(19) United States
(12) Patent Application Publication
(10) Pub. No.: US 2025/0138246 A1
(43) Pub. Date: May 1, 2025

(54) FERRULE ROTARY MATING PART AND OPTICAL SWITCH

(71) Applicant: NIPPON TELEGRAPH AND TELEPHONE CORPORATION, Tokyo (JP)

(72) Inventors: Chisato FUKAI, Musashino-shi, Tokyo (JP); Yoshiteru ABE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/681,624

(22) PCT Filed: Aug. 11, 2021
(86) PCT No.: PCT/JP2021/029600

§ 371 Date: Feb. 6, 2024

(51) Int. Cl. G02B 6/36

(52) U.S. Cl. CPC G02B 6/3604

(57) ABSTRACT

An object of the present invention is to provide a ferrule rotation engagement unit and an optical switch using the same capable of realizing stable optical characteristics in optical path switching with low power consumption and more economically.

A ferrule rotation engagement unit according to the present disclosure includes a first ferrule and a second ferrule in which core centers of one or a plurality of single-core fibers are disposed on a circumference having a predetermined radius from a center in the cross section of the ferrule, a cylindrical sleeve into which one end of a convex shape of the first ferrule and the second ferrule are inserted, a spring that apply pressure to the first flange or the second flange in a direction in which the first ferrule and the second ferrule abut against each other, and a holder that holds the first ferrule, the second ferrule, and the sleeve so that the center axes of the first ferrule and the second ferrule are aligned.

### TECHNICAL FIELD

The present invention relates to a ferrule rotation joint portion used for switching of a path of an optical line mainly using a single-mode optical fiber in an optical fiber network, and an optical switch using the same.

### BACKGROUND ART

As an all-optical switch that performs path switching of light as it is, a scheme for performing switching by rotating a cylindrical ferrule into which a multi-core fiber is inserted has been proposed (see PTL 1, for example). This makes it possible to eliminate the need for optical components such as lenses or prisms, and simplifies a configuration of an optical switch.

### CITATION LIST

### Patent Literature

[PTL 1] Japanese Patent Application Publication No. H2-82212

### [Non Patent Literature]

[NPL 1] B. Jian, “The Non-Contact Connector: A New Category of Optical Fiber Connector,” 2015 Optical Fiber Communications Conference and Exhibition (OFC), W2A. 1, 2015.
[NPL 2] Hajime Arao, Sho Yakabe, Fumiya Uehara, Dai Sasaki, Takayuki Shimazu, “FlexAirConnecT, Dust Insensitive Multi-Fiber Connector with Low Loss and Low Mating Force,” July 2018, SEI Technical Review, No. 193, pp. 26-31, 2018.

### SUMMARY OF INVENTION

### Technical Problem

However, in optical path switching using a cylindrical ferrule into which a multi-core fiber is inserted, which is described in PTL 1, a center axis is aligned by inserting a ferrule in close contact with a sleeve, and a large amount of energy is required for driving of rotation and a large amount of electric power is required due to a frictional force between the ferrule and the sleeve. Further, in order to prevent degradation of optical characteristics such as a connection loss due to damage to an opposing fiber end surface when the ferrule rotates, a mechanism for separating a ferrule end surface each time the ferrule rotates is required, and extra energy is required for drive of rotation. Therefore, PTL 1 has a problem of reduction of energy required for optical path switching.

On the other hand, there is also a method of preventing a fiber end surface from being damaged due to contact through a connection form in which a gap is provided in advance so that there is no fiber contact in a cylindrical ferrule into which an optical fiber is inserted (for example, NPL 1). However, in order to curb signal deterioration due to reflection caused by an air layer between the fiber end surfaces due to the gap, a special coating for preventing the reflection is required, which increases costs. Therefore, NPL 1 has a problem of reduction of a cost of an optical path switching structure.

Further, as another method for preventing the reflection, there is a method of obliquely polishing a ferrule end surface (for example, NPL 2). However, with the obliquely polished ferrule, interference occurs at the ferrule end surface at the time of switching by rotation, or a connection loss increases due to the need for a large gap. Therefore, NPL 2 has a problem of reduction of the interference and the connection loss due to an optical path switching structure.

In order to solve the above problems, an object of the present invention is to provide a ferrule rotation engagement unit and an optical switch using the same capable of realizing stable optical characteristics in optical path switching with low power consumption and more economically.

### Solution to Problem

In order to achieve the above object, in a ferrule rotation engagement unit and an optical switch of the present disclosure, one ends of two ferrules in which single-core fibers are is disposed parallel to the center axes thereof and at the same distance from the center axes thereof has a convex shape, and pressure is applied to any one of the two ferrules by a spring, to cause tip portions of the ends of the two ferrules to abut against each other so that center axes thereof are aligned, and to rotate one of the ferrules about the center axes.

Specifically, the ferrule rotation engagement unit according to the present disclosure includes:
a first ferrule in which core centers of one or a plurality of single-core fibers are disposed on the same circumference from a center in a ferrule cross section;
a second ferrule in which core centers of a plurality of single-core fibers are disposed on a circumference having the same diameter as the circumference on which the core centers of the single-core fibers are disposed in the first ferrule from the center in the ferrule cross section;
a cylindrical sleeve having a hollow portion into which one end of the first ferrule and one end of the second ferrule are inserted so that center axes of the first ferrule and the second ferrule are aligned, a predetermined gap being provided between an outer diameter of each of the first ferrule and the second ferrule and an inner diameter of the hollow portion so that the first ferrule or the second ferrule is able to rotate;
a first flange having a circular collar attached to the other end of the first ferrule and having a center axis coaxial with the first ferrule;
a second flange having a circular collar attached to the other end of the second ferrule and having a center axis coaxial with the second ferrule;
a spring configured to press the first flange or the second flange in a direction in which the first ferrule and the second ferrule abut against each other; and
a holder configured to hold the first ferrule, the second ferrule, the sleeve, the first flange, and the second flange so that the center axes of the first ferrule and the second ferrule are aligned,
the one end of the first ferrule includes
an annular portion having a convex shape in a center axis direction, an end surface of the single-core fiber disposed in the first ferrule being exposed to the annular portion; and a tip portion present on an inner side relative to the annular portion and protruding in the center axis direction relative to the annular portion,
the one end of the second ferrule includes
an annular portion having a convex shape in the center axis direction, an end surface of the single-core fiber disposed in the second ferrule being exposed to the annular portion, and a tip portion present on an inner side relative to the annular portion and protruding in the center axis direction relative to the annular portion, and
the tip portion of the first ferrule and the tip portion of the second ferrule abut against each other.

For example, in the ferrule rotation engagement unit according to the present disclosure,
the tip portion of the first ferrule and the tip portion of the second ferrule are flat surfaces.

For example, in the ferrule rotation engagement unit according to the present disclosure,
an angle formed by the tip portion and the annular portion is 5 degrees or more in each of the first ferrule and the second ferrule.

For example, in the ferrule rotation engagement unit according to the present disclosure,
a gap between the end surface of the single-core fiber exposed to the annular portion of the first ferrule and the end surface of the single-core fiber exposed to the annular portion of the second ferrule whose optical axis coincides with the single-core fiber is 20 μm or less.

For example, in the ferrule rotation engagement unit according to the present disclosure,
the collar of the first flange or the collar of the second flange has a groove on an outer edge thereof, and
the holder has a projection portion shaped to engage with the groove, the projection portion engaging with the groove to prevent rotation about the center axis of the first flange or the second flange.

Specifically, an optical switch according to the present disclosure includes:
the ferrule rotation engagement unit; and
a rotation mechanism configured to rotate any one of the first ferrule and the second ferrule of the ferrule rotation engagement unit around the center axis.

Specifically, an optical switch according to the present disclosure includes:
the ferrule rotation engagement unit; and
a rotation mechanism configured to rotate a rotatable one of the first flange and the second flange of the ferrule rotation engagement unit around the center axis.

In the present invention, one end of each of two ferrules in which the single-core fiber is disposed in parallel to the center axis and at the same distance from the center axis has a convex shape, and pressure is applied to any one of the two ferrules by a spring, to cause tip portions of the ends of two ferrules to abut against each other so that center axes thereof are aligned, and to rotate one of the ferrules about the center axis. This makes it possible to prevent deterioration of optical characteristics such as a connection loss due to scratches on the end surfaces of the optical fibers due to the contact, without contact between the end surfaces of the opposing optical fibers. Further, since an amount of reflection of light can be reduced by making the end surfaces of the optical fibers facing each other non-parallel, it is possible to provide a more economical ferrule rotation engagement unit and an optical switch without requiring a reflective coating.

Further, in the present invention, with a mechanism capable of axially rotating one of the two ferrules of the ferrule rotation engagement unit that performs optical switching, it is possible to minimize energy required by the actuator, that is, torque output and reduce power consumption. Further, since an amount of optical axial misalignment in directions other than the axial rotation of the ferrule is guaranteed by the sleeve and the spring in the ferrule rotation engagement unit, it is possible to reduce a loss. In addition, the present invention is compact and economical because a collimator or a special anti-vibration mechanism is not included, and the present invention is configured of generally and widely used optical connection parts such as a ferrule or a sleeve.

Each of the above inventions can be combined as far as possible.

### Advantageous Effects of Invention

According to the present disclosure, it is possible to provide a ferrule rotation engagement unit and an optical switch using the same capable of realizing stable optical characteristics in optical path switching with low power consumption and more economically.

### BRIEF DESCRIPTION OF DRAWINGS

FIG. 1 illustrates an example of a use pattern of the present invention.

FIG. 2 is a configuration diagram of a ferrule rotation engagement unit according to an embodiment of the present invention.

FIG. 3 is a cross-sectional view of the fixed flange side of the ferrule rotation engagement unit according to the present embodiment of the present invention.

FIG. 4 is a schematic front view of one end of a fixed-side ferrule according to the present embodiment of the present invention.

FIG. 5 is a schematic front view of one end of a rotation-side ferrule according to the present embodiment of the present invention.

FIG. 6 is a schematic diagram illustrating the ferrule and a cylindrical sleeve of the ferrule rotation engagement unit according to the present embodiment of the present invention when viewed in a surface in a longitudinal direction.

FIG. 7 illustrates an example of a relationship between an excess loss and a clearance between a ferrule outer diameter and a sleeve inner diameter.

FIG. 8 is a schematic diagram illustrating in more detail the vicinity of the one end of the ferrule of the ferrule rotation engagement unit according to the present embodiment of the present invention.

FIG. 9 illustrates an example of a relationship between an angle formed by a tip portion and an annular portion and a return loss.

FIG. 10 illustrates an example of a relationship of an excess loss and optical fiber gap.

FIG. 11 is a configuration diagram of an optical switch using the ferrule rotation engagement unit of the present invention.

FIG. 12 illustrates an example of a relationship of a connection loss due to rotation angle deviation and a core arrangement radius.

### DESCRIPTION OF EMBODIMENTS

Hereinafter, embodiments of the present disclosure will be described in detail with reference to the drawings. The present invention is not limited to embodiments shown below. These embodiments are merely illustrative, and the present disclosure can be implemented in various modification and improvement forms on the basis of the knowledge of those skilled in the art. In the present specification and the drawings, it is assumed that constituent elements having the same reference signs are the same as each other.

### EMBODIMENTS

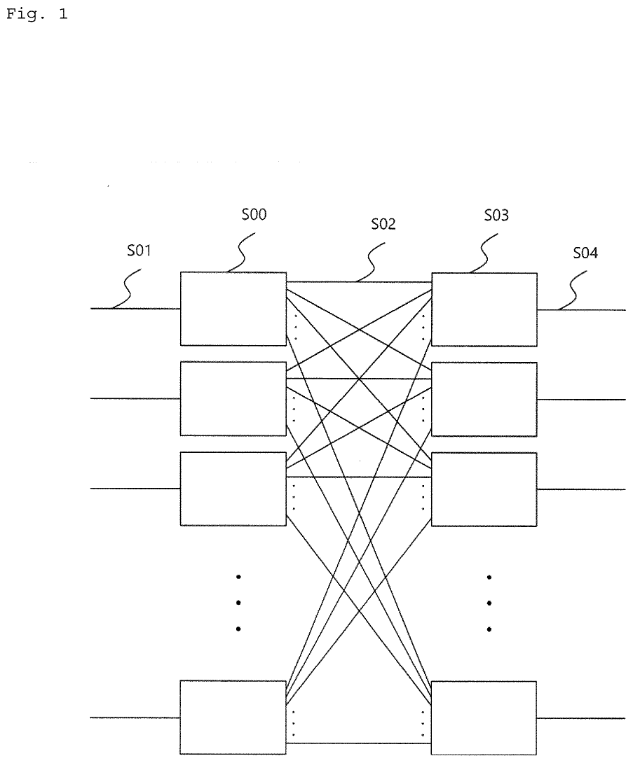

FIG. 1 is a diagram illustrating an example of an embodiment of the present invention. In the present embodiment, a form in which light is incident from an input-side optical fiber S01 and is emitted to an output-side optical fiber S04 will be described, but a direction of the light may be reversed. The present invention can switch an input-side optical fiber S01 connected to a front-stage optical switch component S00 to a specific port of an inter-optical switch optical fiber S02 in the front-stage optical switch component S00, and switch a port of the inter-optical switch optical fiber S02 to the desired output-side optical fiber S04 in a rear-stage optical switch component S03. The present invention is an optical switch corresponding to the front-stage optical switch component S00 and the rear-stage optical switch component S03. Hereinafter, the front-stage optical switch component S00 is abbreviated as an optical switch S00, and the rear-stage optical switch component S03 is abbreviated as an optical switch S03. Since the optical switch S00 and the optical switch S03 have a left-right inversion relationship and have the same configuration, a detailed configuration will be shown hereinafter using the optical switch S00.

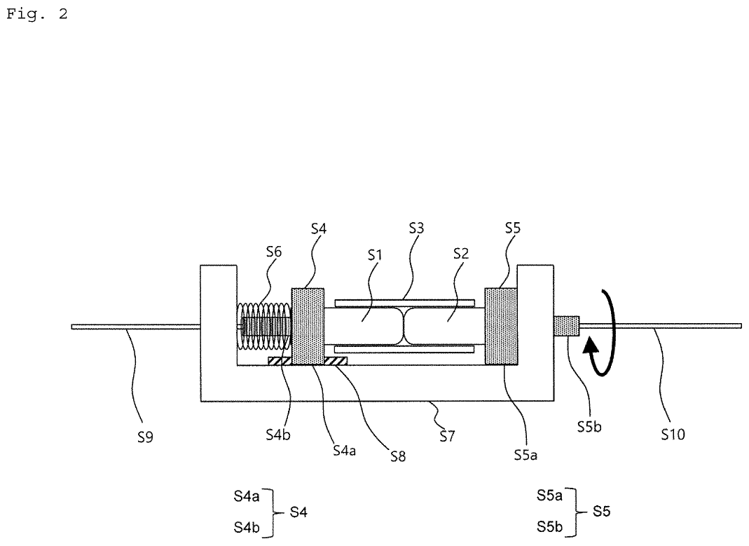

FIG. 2 is a configuration diagram of the ferrule rotation engagement unit S20 according to the present embodiment of the present invention.

The ferrule rotation engagement unit S20 included in the optical switch S00 according to the present embodiment includes
a first ferrule S1 in which core centers of one or a plurality of single-core fibers are disposed on the same circumference from a center in a ferrule cross section;
a second ferrule S2 in which core centers of a plurality of single-core fibers are disposed on a circumference having the same diameter as the circumference on which the core centers of the single-core fibers are disposed in the first ferrule S1 from the center in the ferrule cross section;
a cylindrical sleeve S3 having a hollow portion into which one end of the first ferrule S1 and one end of the second ferrule S2 are inserted so that center axes of the first ferrule S1 and the second ferrule S2 are aligned, a predetermined gap being provided between an outer diameter of each of the first ferrule S1 and the second ferrule S2 and an inner diameter of the hollow portion so that the first ferrule S1 or the second ferrule S2 is able to rotate;
a first flange S4 having a circular collar S4a attached to the other end of the first ferrule S1 and having a center axis coaxial with the first ferrule S1;
a second flange S5 having a circular collar S5a attached to the other end of the second ferrule S2 and having a center axis coaxial with the second ferrule S2;
a spring S6 configured to press the first flange S4 or the second flange S5 in a direction in which the first ferrule S1 and the second ferrule S2 abut against each other; and
a holder S7 configured to hold the first ferrule S1, the second ferrule S2, the sleeve S3, the first flange S4, and the second flange S5 so that the center axes of the first ferrule S1 and the second ferrule S2 are aligned.

The one end of the first ferrule S1 and the one end of the second ferrule S2 are inserted into a hollow portion of a cylindrical sleeve S3 so that center axes thereof are aligned.

The first flange S4 includes a circular collar S4a attached to the other end of the first ferrule S1, and a main body S4b connected to the other end of the first ferrule S1 with the collar S4a interposed therebetween.

The second flange S5 includes a circular collar S5a attached to the other end of the second ferrule S2, and a body portion S5b connected to the other end of the second ferrule S2 with the collar S5a interposed therebetween.

A configuration of the spring S6 is arbitrary as long as the spring S6 can apply pressure so that the one end of the first ferrule S1 and the one end of the second ferrule S2 abut against each other. For example, the spring S6 may be attached to the collar S4a while including the main body S4b inside the spring S6, and apply pressure to the collar S4a from the main body S4b side, as illustrated in FIG. 2. The main body S4b may not be included inside the spring S6, and a plurality of springs may be attached. The spring S6 may be attached to the second flange S5 as is attached to the first flange S4.

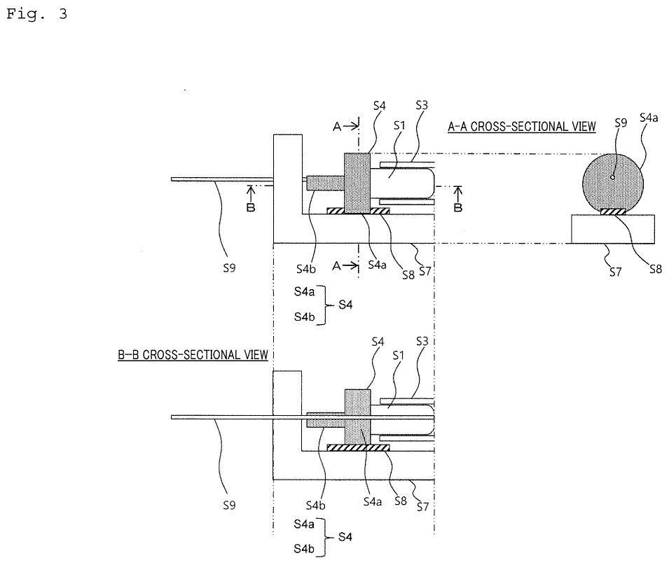

FIG. 3 illustrates an example of a cross-sectional view of the vicinity of the first flange S4 of the ferrule rotation engagement unit S20. An A-A cross-sectional view of FIG. 3 represents a cross-section on a surface perpendicular to a long axis of a fixed-side optical fiber S9. A B-B cross-sectional view of FIG. 3 represents a cross-section on a surface along the long axis of the first optical fiber S9. In the ferrule rotation engagement unit S20 according to the present embodiment,
the collar S4a of the first flange S4 may have a groove on an outer edge thereof, and
the holder S7 may have a projection portion S8 shaped to engage with the groove, and the projection portion S8 engages with the groove to prevent rotation about the center axis of the first flange S4.

Shapes of the groove of the collar S4a and the projection portion S8 are arbitrary as long as the collar S4 can engage with the projection portion S8. For example, as illustrated in the A-A cross-sectional view of FIG. 3, the projection portion S8 has a rectangular shape, the collar S4a has the same rectangular groove as the projection portion S8, and these may engage with each other, thereby preventing rotation about the center axis of the first flange S4.

Further, the groove of the collar S4a and the projection portion S8 have any length in a long axis direction of the first optical fiber S9. For example, as illustrated in the B-B cross-sectional view of FIG. 3, the groove of the collar S4a penetrates in the longitudinal direction of the first optical fiber S9, and a length of the projection portion S8 in the longitudinal direction of the first optical fiber S9 is larger than a thickness of the collar S4a in the longitudinal thickness of the first optical fiber S9, and the entire groove of the collar S4a may engage with a part of the projection portion S8, but the present disclosure is not limited thereto. Although the example in which the collar S4a of the first flange S4 has the groove, and the groove of the collar S4a and the projection portion S8 are engaged with each other is illustrated, rotation around the center axis of the second flange S5 may be prevented with the same structure in the second flange S5, and in this case, optical path switching may be realized by rotating the first flange S4. In the ferrule rotation engagement unit, the ferrule and the flange may be subjected to bearings or low-friction processing in order to reduce driving force for rotation.

The first optical fiber S9 corresponds to the input-side optical fiber S01 in FIG. 1, and the second optical fiber S10 corresponds to the inter-optical switch optical fiber S02 in FIG. 1. When light is incident from the first optical fiber S9, the first ferrule S1 is fixed, and the second ferrule S2 is rotated to connect the first optical fiber S9 to any one core of the second optical fiber S10 so that the incident light can be output from one core of the second optical fiber S10, and such an optical switch S00 can be used as a 1×N relay-type optical switch. On the other hand, it is also possible for light to be incident from the second optical fiber S10. For example, the light is incident on the plurality of single-core fibers in the second optical fiber S10 and the second ferrule S2 is rotated to connect any one core of the second optical fiber S10 to the first optical fiber S9, so that only one light beam selected from a plurality of incident light beams can be output from the first optical fiber S9. Further, as illustrated in FIG. 1, a plurality of optical switches can be combined to construct an N×N optical switch. Although the first ferrule S1 has one core here, it is also possible to arrange a plurality of optical fibers. Further, although the first ferrule S1 has one core and the second ferrule S2 has a plurality of cores, the second ferrule S2 can have one core and the first ferrule S1 can have a plurality of cores. In this case, the first optical fiber S9 corresponds to the inter-optical switch optical fiber S02 in FIG. 1, and the second optical fiber S10 corresponds to the input-side optical fiber S01 in FIG. 1. Hereinafter, the optical switch S00 in which the first ferrule S1 has one core, the second ferrule S2 has a plurality of cores, the first ferrule S1 is a fixed-side ferrule, and the second ferrule is a rotation-side ferrule will be described. Hereinafter, the first optical fiber is the fixed-side optical fiber, and the second optical fiber is the rotation-side optical fiber.

In the ferrule rotation engagement unit S20 according to the present embodiment, as described below, one end of the fixed-side ferrule S1 is formed of an annular portion S12 that has a convex shape in a center axis direction and to which an end surface of the fixed-side optical fiber S9 disposed in the fixed-side ferrule S1 is exposed, and a tip portion S11 that is present on an inner side relative to the annular portion S12 and protrudes in the center axis direction relative to the annular portion S12, one end of the rotation-side ferrule S2 is formed of an annular portion S12 that has a convex shape in the center axis direction and to which an end surface of the rotation-side optical fiber S10 disposed in the rotation-side ferrule S2 is exposed, and a tip portion S11 that is present on an inner side relative to the annular portion S12 and protrudes in the center axis direction relative to the annular portion S12, and
the tip portion S11 of the fixed-side ferrule S1 and the tip portion S11 of the rotation-side ferrule S2 abut against each other.

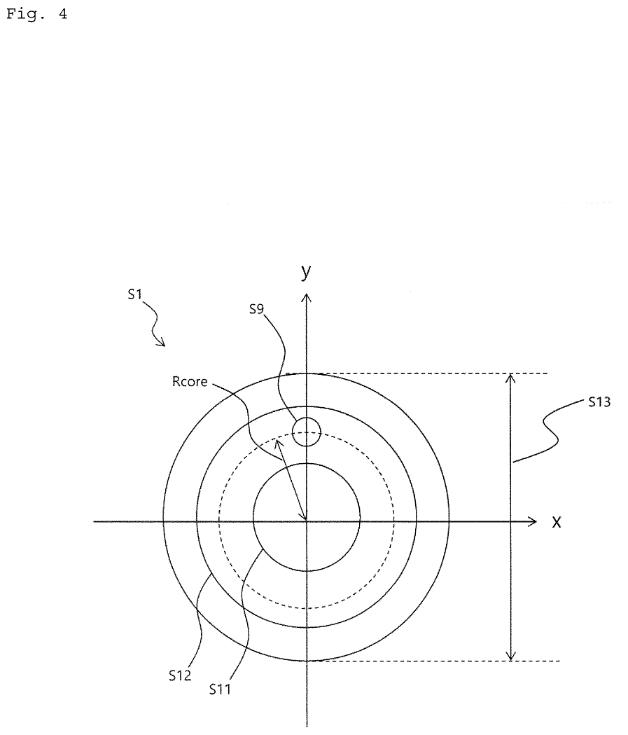

FIG. 4 is a schematic front view of one end of the fixed-side ferrule S1 according to the present embodiment of the present invention. The present invention is characterized in that a core center of the fixed-side optical fiber S9 is disposed on a circumference of a circle having a core arrangement radius Rcore with respect to a center of the fixed-side ferrule S1, as illustrated in FIG. 4. Although an example in which the one-core fixed-side optical fiber S9 is disposed on a y-axis (x=0) is shown in FIG. 4, the core center of the fixed-side optical fiber S9 may be disposed on the circumference of the circle having the core arrangement radius Rcore, and the present invention is not limited thereto. Further, the fixed-side optical fiber S9 is disposed in the annular portion S12 disposed on the outer side of the tip portion S11. Further, the end surface of the fixed-side optical fiber S9 is exposed to the annular portion S12.

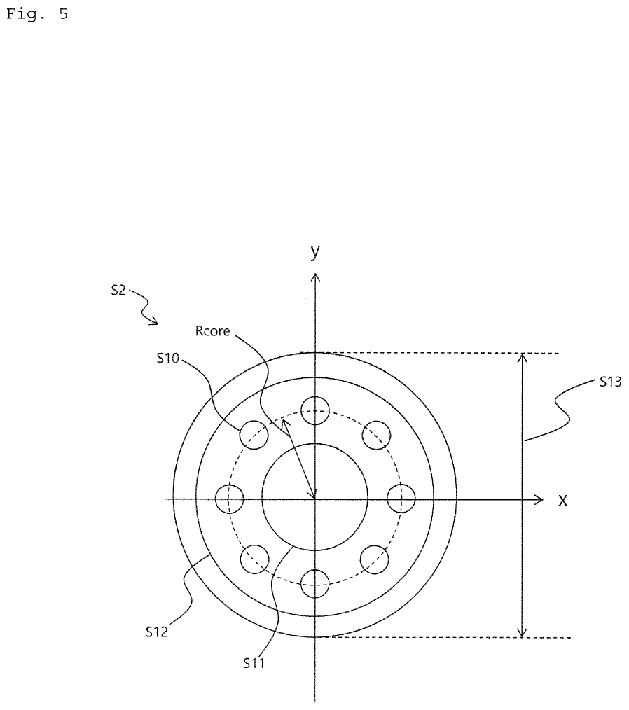

FIG. 5 is a schematic front view illustrating one end of the rotation-side ferrule S2 according to the present embodiment of the present invention. The present invention is characterized in that, as illustrated in FIG. 5, core centers of a plurality of rotation-side optical fibers S10 are disposed on a circumference of a circle having the core arrangement radius Rcore with respect to a center of the rotation-side ferrule S2. Although the example in which a total of eight rotation-side optical fibers S10 are disposed is shown in FIG. 5, core centers of the plurality of rotation-side optical fibers S10 may be disposed on the circumference of the circle having the core arrangement radius Rcore, and the present invention is not limited thereto. Further, the rotation-side optical fiber S10 is disposed in the annular portion S12 disposed on the outer side of the tip portion S11, like the fixed-side optical fiber S9. Further, an end surface of the rotation-side optical fiber S10 is exposed to the annular portion S12.

It is important to minimize a transmission loss in connecting the fixed-side optical fiber S9 to the rotation-side optical fiber S10, and it is preferable for the fixed-side optical fiber S9 and the rotation-side optical fiber S10 to have the same optical characteristics in that each core of the rotation-side optical fiber S10 has substantially the same mode field diameter as that of the fixed-side optical fiber S9. In addition, it is important to minimize an excessive loss due to axial misalignment, and it is preferable for a ferrule outer diameter S13 of the rotation-side ferrule S2 to be approximately the same as a ferrule outer diameter S13 of the fixed-side ferrule S1.

Although the fixed-side optical fiber S9 and the rotation-side optical fiber S10 are formed of quartz glass in the present embodiment, the fixed-side optical fiber S9 and the rotation-side optical fiber S10 may be optical fibers capable of communicating signal light in a communication wavelength band and are not limited thereto. Although in the present embodiment, an example in which the tip portions S11 of the fixed-side ferrule S1 and the rotation-side ferrule S2 are flat surfaces is shown, the tip portions S11 do not need to be flat and, for example, one of the fixed-side ferrule S1 and the rotation-side ferrule S2 may have a convex shape, and the other may have a concave shape that is in close contact with the convex shape.

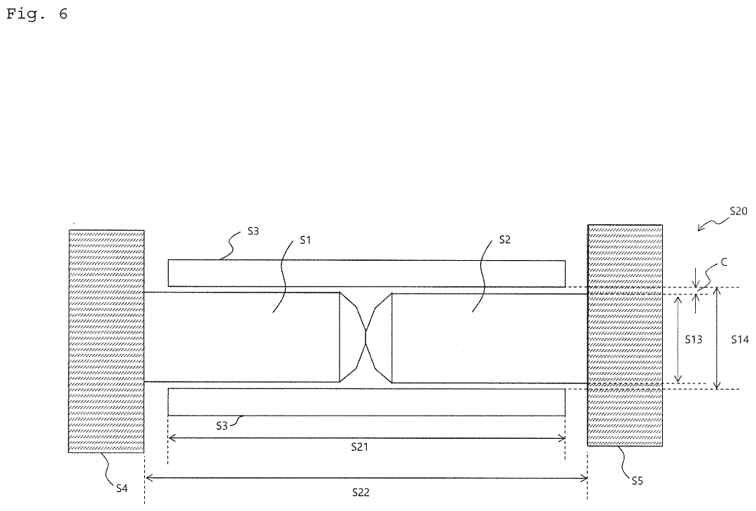

FIG. 6 is a schematic diagram illustrating the ferrule and the cylindrical sleeve of the ferrule rotation engagement unit S20 according to the present embodiment of the present invention on a surface in the longitudinal direction. The fixed-side ferrule S1 into which the fixed-side optical fiber S9 is inserted and the rotation-side ferrule S2 into which the rotation-side optical fiber S10 is inserted are aligned with the cylindrical sleeve S3 having an inner diameter S14 that is one size larger than the ferrule outer diameter S13 on the order of sub-μm, and a slight clearance C of about sub-μm is provided between the fixed-side ferrule S1 and the rotation-side ferrule S2 in order to control axial misalignment within a certain allowable range and not to hinder axial rotation of the rotation-side ferrule S2. In addition, since the end surfaces of the fixed-side ferrule S1 and the rotation-side ferrule S2 abut against each other, a length S21 in Longitudinal direction of cylindrical sleeve S3 is set to be smaller than a length S22 that is a sum of a length in a longitudinal direction of the cylindrical sleeve S1 and a length in the longitudinal direction of the rotation-side ferrule S2, that is, a distance between the fixed-side flange S4 and the rotation-side flange S5.

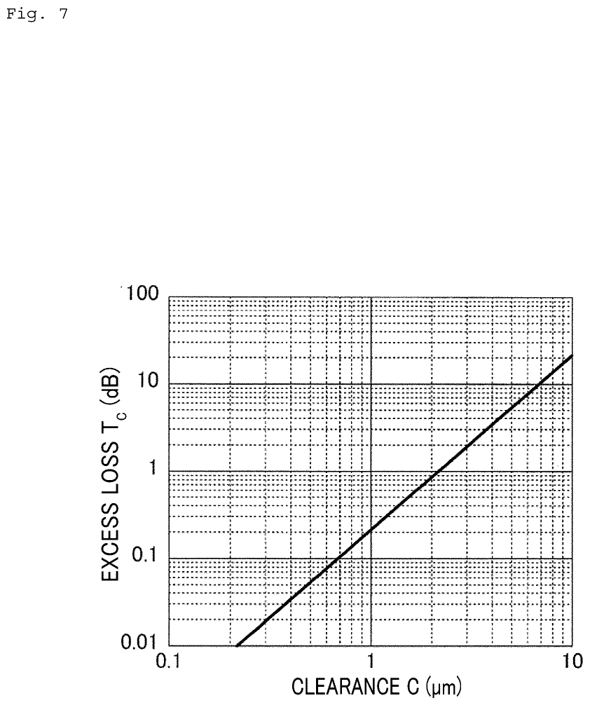

FIG. 7 is a diagram illustrating an example of a relationship between the clearance C of the ferrule outer diameter S13 of the fixed-side ferrule S1 and the rotation-side ferrule S2 and a sleeve inner diameter S14 of the cylindrical sleeve S3 and an excess loss Tc. In optical coupling between optical fibers, axial misalignment of fiber cores causes the excess loss. Since an increase in the excess loss is a factor that limits a total length of the optical path, it is necessary to reduce the axial misalignment of the fiber core. Here, since the clearance C between the ferrule outer diameter S13 and the sleeve inner diameter S14 corresponds to axial misalignment of the fiber core, a relationship between the clearance C (unit: μm) between the ferrule outer diameter S13 and the sleeve inner diameter S14 and the excess loss Tc (unit: dB) can be expressed in Math. 1.

$$\begin{matrix}[ Math . 1 ] & \\ {T}_{C} = {( \frac{2 {w}_{1} {w}_{2}}{{w}_{1}^{2} + {w}_{2}^{2}} )}^{2} exp [ 1 \frac{2 {C}^{2}}{{w}_{1}^{2} + {w}_{2}^{2}} ] & ( 1 )\end{matrix}$$

Here, W₁ and W₂ are mode field radii of the cores of the fixed-side optical fiber S9 and the rotation-side optical fiber S10, respectively, and FIG. 7 is a diagram illustrating a loss when the mode field radii of the cores of the fixed-side optical fiber S9 and the rotation-side optical fiber S10 are both 9 μm. For example, when the ferrule outer diameter S13 and the sleeve inner diameter S14 are processed so that the clearance C is 0.7 μm or less, it is possible to curb a maximum excess loss to about 0.1 dB or less. Further, when the maximum excess loss is set to 0.2 dB, it is necessary to process the ferrule outer diameter S13 and the sleeve inner diameter S14 so that the clearance C is 1 μm or less.

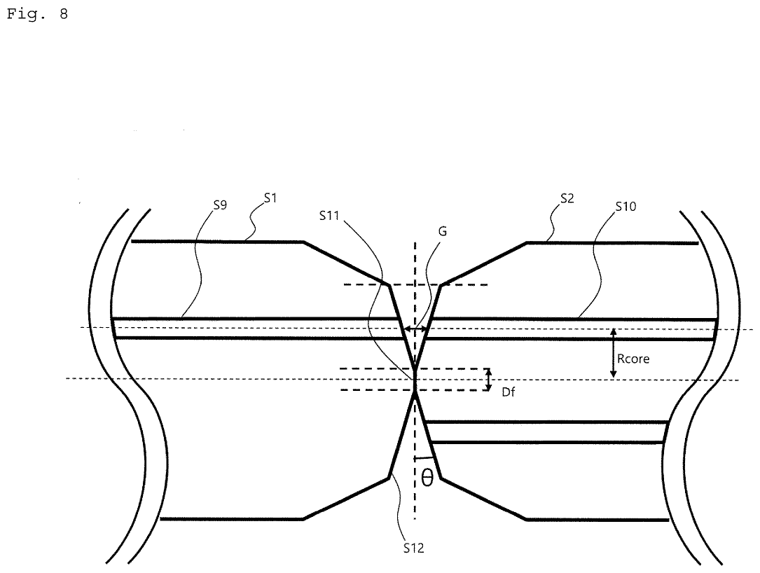

FIG. 8 is a schematic diagram illustrating in more detail the vicinity of one end of the ferrule of the ferrule rotation engagement unit S20 according to the present embodiment of the present invention. One end of the fixed-side ferrule S1 and the rotation-side ferrule S2 has a convex shape in the center axis direction. The tip portions S11 of the fixed-side ferrule S1 and the rotation-side ferrule S2 abut against each other. The fixed-side optical fiber S9 and the rotation-side optical fiber S10 are disposed in the annular portions S12 of the fixed-side ferrule S1 and the rotation-side ferrule S2, and the end surfaces thereof are exposed, as described above. The end surfaces of the fixed-side optical fiber S9 and the rotation-side optical fiber S10 retreat from the tip portion S11 in order to prevent the end surfaces from contacting each other and being damaged at the time of switching by rotation. Further, at the end surfaces of the fixed-side optical fiber S9 and the rotation-side optical fiber S10, an angle θ formed between the tip portion S11 and the annular portion S12 is controlled in order to curb deterioration of signal characteristics due to reflection. Although in the present embodiment, an example in which an end surface of the annular portion S12 is formed linearly in a direction of retreating from the tip portion S11 is illustrated in FIG. 8, the annular portion S12 does not have to have a linear shape and may have, for example, a spherical shape.

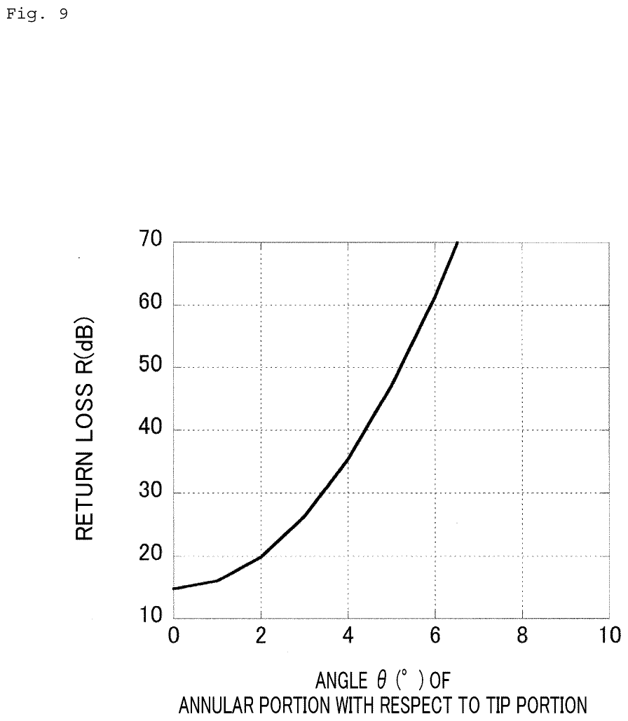

FIG. 9 is a diagram illustrating an example of a relationship between an angle θ of the annular portion S12 with respect to the tip portion S11 and a return loss R. When there is a region with a different refractive index between the end surface of the fixed-side optical fiber S9 and the end surface of the rotation-side optical fiber S10 in the ferrule rotation engagement unit S20, the signal characteristics are degraded due to reflection. In the configuration of the present invention illustrated in FIG. 8, since there is a gap G between the end surface of the fixed-side optical fiber S9 and the end surface of the rotation-side optical fiber S10, and quartz glass and air have different refractive index, it is necessary to devise a way of reducing the reflection. In the present invention, reflection is reduced by controlling the angle θ of the annular portion S12. A relationship between the angle θ (unit: degrees) of the annular portion S12 with respect to the tip portion S11 and the return loss R (unit: dB) can be expressed by Math. 2.

$$\begin{matrix}[ Math . 2 ] & \\ R = 10 \frac{{( π \times {n}_{1} \times {ω}_{1} )}^{2}}{{λ}^{2}} \times log ( e ) \times {( 2 θ )}^{2} + {R}_{0} & ( 2 )\end{matrix}$$

where n₁, ω₁, and λ are a refractive index of the optical fiber, a mode field radius of an optical fiber core, and a signal wavelength, respectively. Further, R₀ is a return loss at a flat end surface, and can be expressed by Math. (3).

$$\begin{matrix}[ Math . 3 ] & \\ {R}_{0} = - 10 \cdot log [ {( \frac{{n}_{1} - {n}_{2}}{{n}_{1} + {n}_{2}} )}^{2} ] & ( 3 )\end{matrix}$$

Where n₂ is a refractive index of a light reception medium. In the present embodiment, when the wavelength λ is 1310 nm and the mode field radius ω₁ is 4.5 μm, a return loss R₀ at the flat end surface is 14.7 dB, and for example, it is possible to hold the return loss R of 40 dB or more by setting the angle of the annular portion S12 with respect to the tip portion S11 to 5 degrees or more.

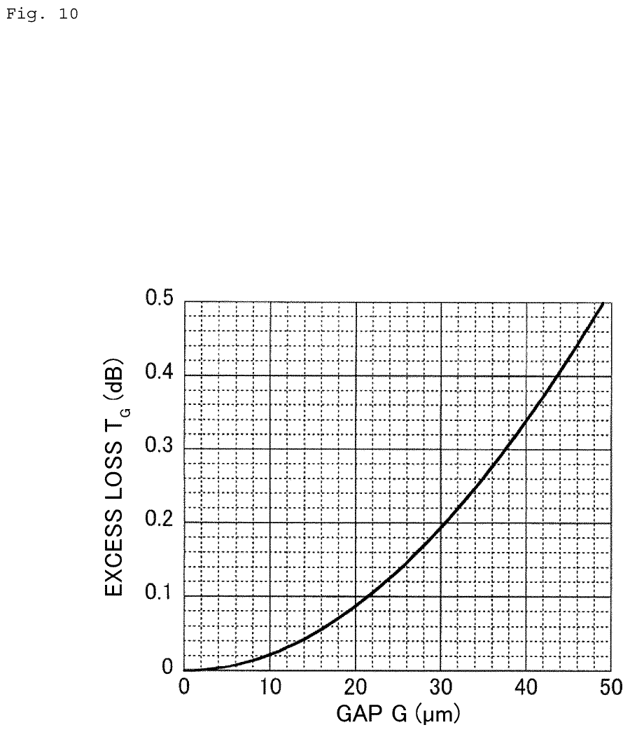

FIG. 10 is a diagram illustrating an example of a relationship between the gap G and an excess loss TG. In optical coupling between the fixed-side optical fiber S9 and the rotation-side optical fiber S10, when there is the gap G between the end surface of the fixed-side optical fiber S9 and the end surface of the rotation-side optical fiber S10, a distribution of emitted light of the fixed-side optical fiber S9 spreads and coupling efficiency with the core of the rotation-side optical fiber S10 decreases, and thus, excessive loss is caused. The relationship between the gap G (unit: μm) and the excess loss TG (unit: dB) can be expressed by Math. 4.

$$\begin{matrix}[ Math . 4 ] & \\ {T}_{G} = \frac{4 [ 4 {G}^{2} + \frac{{w}_{1}^{2}}{{w}_{2}^{2}} ]}{{[ 4 {G}^{2} + \frac{{w}_{2}^{2} + {w}_{1}^{2}}{{w}_{2}^{2}} ]}^{2} + 4 {G}^{2} + \frac{{w}_{2}^{2}}{{w}_{1}^{2}}} & ( 4 )\end{matrix}$$

Here, W₁ and W₂ are the mode field radii of the cores of the fixed-side optical fiber S9 and the rotation-side optical fiber S10, respectively, and FIG. 10 is a diagram showing a loss when the mode field diameters of the cores of the fixed-side optical fiber S9 and the rotation-side optical fiber S10 are both 9 μm. For example, when the gap G between the end surface of the fixed-side optical fiber S9 and the end surface of the rotation-side optical fiber S10 is adjusted to 20 μm or less, it is possible to curb the excess loss to 0.1 dB or less.

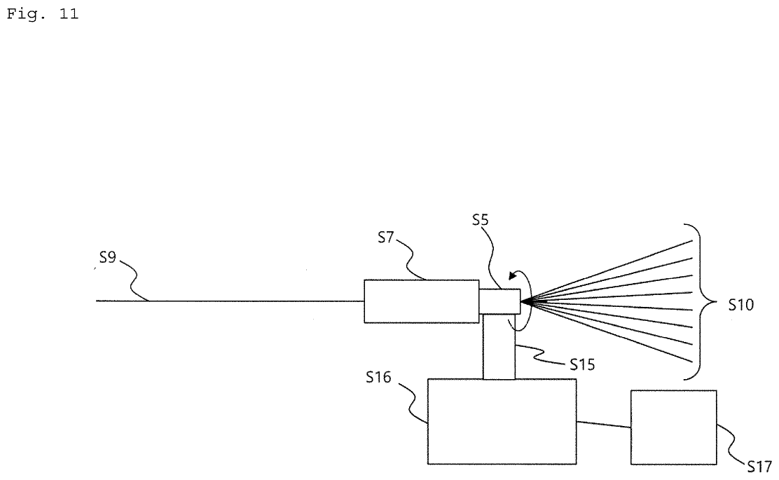

FIG. 11 is a configuration diagram of an optical switch using the ferrule rotation engagement unit S20 of the present invention. The optical switch according to the present disclosure includes the ferrule rotation engagement unit S20, and a rotation mechanism S15 that rotates one of the first ferrule S1 and the second ferrule S2 of the ferrule rotation engagement unit S20 around a center axis.

Here, the rotation mechanism S15 of the optical switch according to the present disclosure may rotate a rotatable one of the first flange S4 and the second flange S5 about the center axis. For example, when the rotation of the first flange S4 is stopped by a structure of the ferrule rotation engagement unit S20 in FIGS. 2 and 3, the rotation mechanism S15 is connected to the second flange S5 to rotate the second flange S5, as illustrated in FIG. 11.

An actuator S16 performs arbitrary angle rotation according to a signal from a control circuit S17. The rotation-side flange S5 rotates when an output of the actuator S16 is transmitted via the rotation mechanism S15. The rotation-side optical fiber S10 may be provided with a constant extra length portion for allowing twisting due to rotation.

Next, requirements related to the actuator S16 in FIG. 11, the fixed-side ferrule S1 described in FIG. 4, and the rotation-side ferrule S2 described in FIG. 5 will be described. The actuator S16 is a driving mechanism that performs rotation at arbitrary angle steps according to a pulse signal from the control circuit S17 and has a constant static torque for each angle step, and for example, a stepping motor is used. Any other method may be used as long as the actuator S16 is the driving mechanism that performs the rotation at arbitrary angle steps according to the pulse signal from the control circuit S17 and has the constant static torque for each angle step. The rotation speed or rotation angle may be determined by a period and number of pulses of the pulse signal from the control circuit 17, and the angle step or static torque may be adjusted via a reduction gear. As described above, the present invention is characterized in that, since the rotation-side ferrule S2 in the ferrule rotation engagement unit S20 is designed to rotate about the axis, the static torque required to hold a rotation angle of the rotation-side ferrule S2 is assigned by the actuator S16.

This makes it possible to provide a self-holding function that does not require power at the time of being stationary after switching, to minimize driving energy at the time of switching the optical path, and to provide an optical switch with low power consumption.

Here, the present invention is characterized in that, in the stepping motor, when the number of angle steps in which the angle position is held at the time of stopping of power supply is defined as the number of static angle steps, the number of static angle steps is a natural number multiple of the number of cores having the same core arrangement radius Rcore of the rotation-side optical fiber S10.

Further, when a connection loss due to the rotation angle deviation at the ferrule rotation engagement unit S20 is TR (unit: dB), the rotation angle deviation related to the static angle accuracy of the stepping motor is Φ (unit: °), and the core arrangement radius is Rcore (unit: μm), a relationship among these can be expressed in Math. 6.

$$\begin{matrix}[ Math . 5 ] & \\ {T}_{R} = {( \frac{2 {w}_{1} {w}_{2}}{{w}_{1}^{2} + {w}_{2}^{2}} )}^{2} exp [ 1 \frac{2 {( 2 {R}_{core} sin 2 π \frac{ϕ}{360} )}^{2}}{{w}_{1}^{2} + {w}_{2}^{2}} ] & ( 5 )\end{matrix}$$

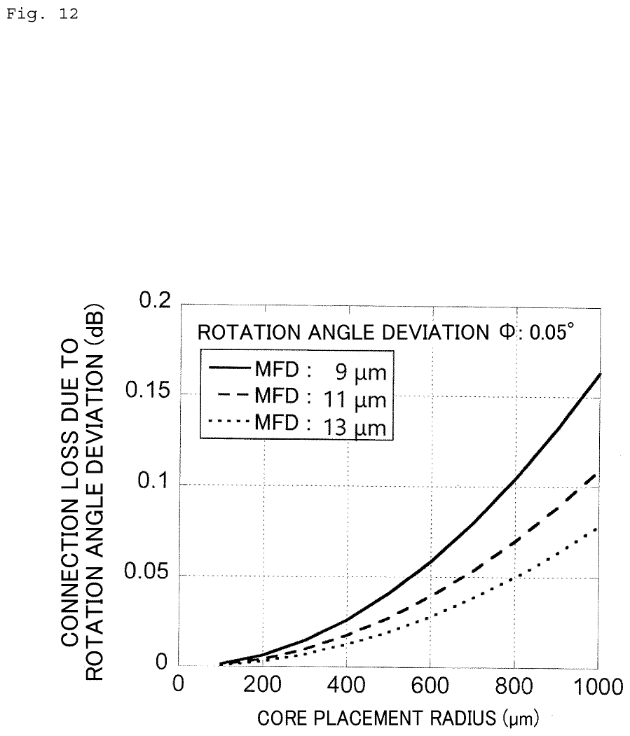

An example of a relationship between the core arrangement radius Rcore and a connection loss TR due to the rotation angle deviation is illustrated in FIG. 12. Generally, the angular accuracy of the stepping motor is about 3 to 5%, and in FIG. 12, the rotation angle deviation Φ is 0.05 degrees. When the core arrangement radius Rcore is larger, the connection loss is increased and strict static angle accuracy is obtained and, for example, if the connection loss is 0.1 dB, it is necessary for the core arrangement radius Rcore to be set to 800 μm or less when the mode field diameter (MFD) is 9 μm. Further, when an optical fiber with a larger mode field diameter is used, it is also possible to reduce the connection loss.

In the present invention, one end of each of two ferrules in which the single-core fiber is disposed in parallel to the center axis and at the same distance from the center axis has a convex shape, and pressure is applied to any one of the two ferrules by a spring, to cause tip portions of the ends of two ferrules to abut against each other so that center axes thereof are aligned, and to rotate one of the ferrules about the center axis, thereby switch between opposing optical fibers. One end of two ferrules has a convex shape, the tip portion S11 in the one end of the two ferrules abut against each other so that the center axes of the two ferrules are aligned, and one of the ferrules is rotated, thereby making it possible to prevent deterioration of optical characteristics such as a connection loss due to scratches on the end surfaces of the optical fibers due to the contact without contact between the end surfaces of the opposing optical fibers. Further, since an amount of reflection of light can be reduced by making the end surfaces of the opposing optical fibers non-parallel, it is possible to provide a more economical ferrule rotation engagement unit and an optical switch without requiring a reflective coating.

Further, in the present invention, with a mechanism capable of axially rotating one of the input side and the output side of the ferrule rotation engagement unit that performs optical switching, it is possible to minimize energy required by the actuator, that is, torque output and reduce power consumption. Further, since an amount of optical axial misalignment in directions other than the axial rotation of the ferrule S2 is guaranteed by the sleeve S3, it is possible to reduce a loss. In addition, the present invention is compact and economical because a collimator or a special anti-vibration mechanism is not included, and the present invention is configured of generally and widely used optical connection parts such as a ferrule or a sleeve.

Therefore, according to the present invention, it is possible to provide a ferrule rotation engagement unit and an optical switch capable of realizing stable optical characteristics against external factors such as temperature or vibration with low power consumption and more economically. As a result, this can be used as an optical switch for switching paths in any facility regardless of places in an optical line using a single-mode optical fiber in an optical fiber network.

Each of the inventions can be combined as much as possible.

### INDUSTRIAL APPLICABILITY

The ferrule rotation engagement unit and the optical switch according to the present disclosure can be applied to the optical communications industry.

### REFERENCE SIGNS LIST

S00 Front-stage optical switch component
S01 Input-side optical fiber
S02 Inter-optical switch optical fiber
S03 Rear-stage optical switch component
S04 Output-side optical fiber
S1 First ferrule
S2 Second ferrule
S3 Cylindrical sleeve
S4 First flange
S5 Second flange
S6 Spring
S7 Holder
S8 Flange fixing projection portion
S9 First optical fiber
S10 Second optical fiber
S11 Tip portion
S12 Annular portion
S13 Ferrule outer diameter
S14 Sleeve inner diameter
S15 Rotation mechanism
S16 Actuator
S17 Control circuit
S20 Ferrule rotation engagement unit
S21 Length in Longitudinal direction of cylindrical sleeve
S22 length that is sum of length in longitudinal direction of first ferrule and length in longitudinal direction of second ferrule

1. A ferrule rotation engagement unit comprising:
a first ferrule in which core centers of one or a plurality of single-core fibers are disposed on the same circumference from a center in a ferrule cross section;
a second ferrule in which core centers of a plurality of single-core fibers are disposed on a circumference having the same diameter as the circumference on which the core centers of the single-core fibers are disposed in the first ferrule from the center in the ferrule cross section;
a cylindrical sleeve having a hollow portion into which one end of the first ferrule and one end of the second ferrule are inserted so that center axes of the first ferrule and the second ferrule are aligned, a predetermined gap being provided between an outer diameter of each of the first ferrule and the second ferrule and an inner diameter of the hollow portion so that the first ferrule or the second ferrule is able to rotate;
a first flange having a circular collar attached to the other end of the first ferrule and having a center axis coaxial with the first ferrule;
a second flange having a circular collar attached to the other end of the second ferrule and having a center axis coaxial with the second ferrule;
a spring configured to press the first flange or the second flange in a direction in which the first ferrule and the second ferrule abut against each other; and
a holder configured to hold the first ferrule, the second ferrule, the sleeve, the first flange, and the second flange so that the center axes of the first ferrule and the second ferrule are aligned,
the one end of the first ferrule includes
an annular portion having a convex shape in a center axis direction, an end surface of the single-core fiber disposed in the first ferrule being exposed to the annular portion;
and a tip portion present on an inner side relative to the annular portion and protruding in the center axis direction relative to the annular portion,
the one end of the second ferrule includes
an annular portion having a convex shape in the center axis direction, an end surface of the single-core fiber disposed in the second ferrule being exposed to the annular portion, and a tip portion present on an inner side relative to the annular portion and protruding in the center axis direction relative to the annular portion, and
the tip portion of the first ferrule and the tip portion of the second ferrule abut against each other.

2. The ferrule rotation engagement unit according to claim 1, wherein the tip portion of the first ferrule and the tip portion of the second ferrule are flat surfaces.

3. The ferrule rotation engagement unit according to claim 1, wherein in each of the first ferrule and the second ferrule, an angle formed by the tip portion and the annular portion is 5 degrees or more.

4. The ferrule rotation engagement unit according to claim 1, wherein a gap between the end surface of the single-core fiber exposed to the annular portion of the first ferrule and the end surface of the single-core fiber exposed to the annular portion of the second ferrule whose optical axis coincides with the single-core fiber is 20 μm or less.

5. The ferrule rotation engagement unit according to claim 1, wherein the collar of the first flange or the collar of the second flange has a groove on an outer edge thereof, and
the holder has a projection portion shaped to engage with the groove, the projection portion engaging with the groove to prevent rotation about the center axis of the first flange or the second flange.

6. An optical switch comprising:
the ferrule rotation engagement unit according to claim 1; and
a rotation mechanism configured to rotate any one of the first ferrule and the second ferrule of the ferrule rotation engagement unit around the center axis.

7. An optical switch comprising:
the ferrule rotation engagement unit according to claim 5; and
a rotation mechanism configured to rotate rotatable one of the first flange and the second flange of the ferrule rotation engagement unit around the center axis.
